(19) United States
(12) Patent Application Publication
(10) Pub. No.: US 2004/0182183 A1
(43) Pub. Date: Sep. 23, 2004

(54) Measurement device for early detection of damage to a machine part

(76) Inventors: Armin Brand, Bad Kissingen (DE); Michael Zahner, Elfershausen (DE); Michael Weigand, Elfershausen (DE); Walter Graf, Euerdorf (DE)

Correspondence Address: WILLIAM COLLARD, COLLARD & ROE, P.C., 1077 NORTHERN BOULEVARD, ROSLYN, NY, 11576, US

(21) Appl. No.: 10/778,815

(22) Filed: Feb. 13, 2004

(30) Foreign Application Priority Data
Feb. 15, 2003 (DE) 203 02 454.0

(51) Int. Cl. G01M 13/04

(52) U.S. Cl. 73/865.9

(57) ABSTRACT

A measurement device is provided for early detection of damage to a machine part that is supplied with lubricant from a decentralized electromechanical lubricant dispenser. The device has a measurement sensor and a measurement instrument that has a circuit board having integrated circuits, interfaces for the measurement sensor and for a connection to an electronic control of the lubricant dispenser, as well as a battery, which is soldered onto the circuit board, in order to prevent voltage drops. The measurement sensor has a device for recording analog measurement signals, provided with power by the measurement instrument. Furthermore, the arrangement is made so that the integrated circuits release the power supply of the measurement sensor at predetermined intervals, only for a short period of time, and interrupt the power supply again after the current measurement values have been detected.

### CROSS REFERENCE TO RELATED APPLICATIONS

Applicants claim priority under 35 U.S.C. §119 of German Application No. 203 02 454.0 filed Feb. 15, 2003.

### BACKGROUND OF THE INVENTION

1. Field of the Invention

The present invention relates to a measurement device for early detection of damage to a machine part that is supplied with lubricant from a decentralized electromechanical lubricant dispenser. The device has a measurement sensor and a measurement instrument that has a circuit board having integrated circuits, interfaces for the measurement sensor and for a connection to an electronic control of the lubricant dispenser, as well as a battery.

2. The Prior Art

A measurement device having the characteristics described initially is known from WO 01/25678 A1. The known measurement device allows status-oriented maintenance of a roller bearing without a connection to a central roller bearing monitoring system. For this purpose, the measurement device recognizes the start of a bearing effect or a lubricant deficiency state. The lubricant dispenser to which the measurement device is connected delays the progression of the damage by means of suitable additional lubrication, predetermined by the electronic control. A bearing replacement that might be necessary can therefore be performed within the scope of maintenance work planned over a longer period of time.

### SUMMARY OF THE INVENTION

It is an object of the present invention to provide a measurement device of the type described initially, which functions in self-sufficient and power-saving manner. Furthermore, the measurement device should be usable in areas that are protected against explosion.

This object is achieved according to the invention by a measurement device in which the measurement sensor has a device for recording analog measurement signals, provided with power by the measurement instrument. The integrated circuits release the power supply of the measurement sensor at predetermined intervals, only for a short period of time. The integrated circuits then interrupt the power supply again after the current measurement values have been detected. The battery is soldered onto the circuit board, in order to prevent voltage drops. The battery allows a self-sufficient power supply of the measurement sensor and the measurement instrument. Because the release of the power supply of the measurement sensor occurs for only a short period of time, a clear reduction in power consumption is achieved.

Soldering the battery onto the circuit board prevents voltage drops and prevents the formation of sparks at the contact points between the circuit board and the battery, so that the measurement device can also be used in areas that are protected against explosion. According to the invention, long useful lifetimes of up to several years can be achieved without replacing the battery.

The battery can be a lithium battery with a battery housing welded to be pressure-sealed. Lithium batteries have very long operating times. The battery housing welded to be pressure-sealed prevents the penetration of humidity, which can impair the function of the battery.

Start of damage to a machine part can express itself both by means of increased friction between fixed and moving components of the machine part and by means of an increased vibration of the machine part. According to a preferred embodiment of the invention, the measurement sensor contains a semiconductor module for temperature measurements and/or a double-axis sensor for recording acceleration values.

The measurement sensor can be equipped with an analog/digital converter. This arrangement results in a further reduction in power consumption, because the transmission of digital signals from the measurement sensor to the measurement instrument causes only an extremely low demand for energy.

According to another preferred embodiment of the invention, the measurement sensor has an integrated circuit (IC) module for forming the average of the measurement signals. This arrangement reduces the influence of short-term extreme values and incorrect measurements on the lubricant supply of the machine part.

### BRIEF DESCRIPTION OF THE DRAWINGS

Other objects and features of the present invention will become apparent from the following detailed description considered in connection with the accompanying drawing. It should be understood, however, that the drawing is designed for the purpose of illustration only and not as a definition of the limits of the invention.

In the drawing,

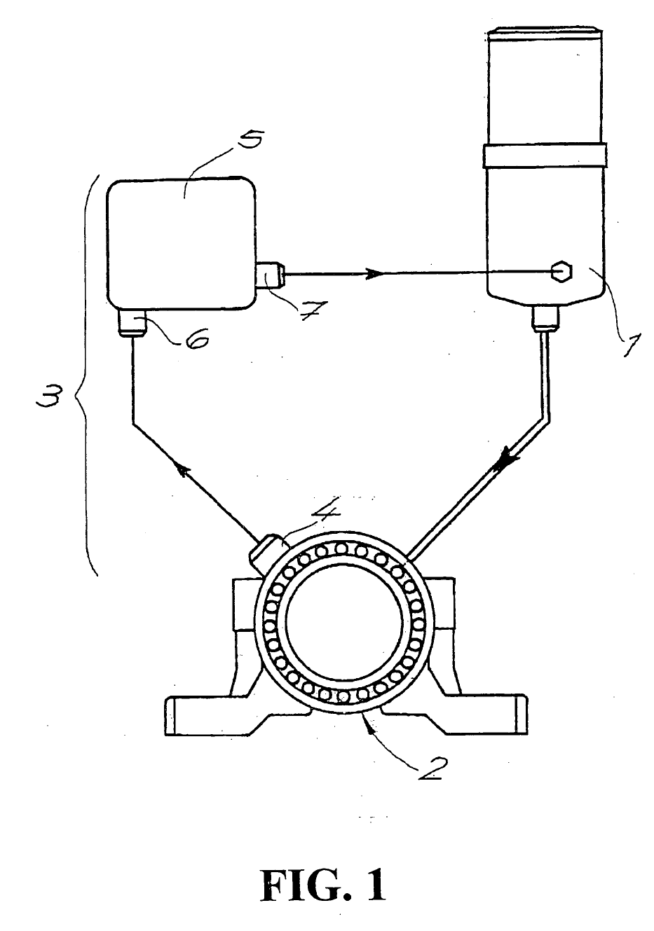

The sole FIGURE, FIG. 1, schematically shows a device for lubricating a roller bearing including a measurement device according to an embodiment of the invention.

### DETAILED DESCRIPTION OF PREFERRED EMBODIMENTS

FIG. 1 shows a device for lubricating a roller bearing having a decentralized electromechanical lubricant dispenser 1, which supplies a roller bearing 2 with lubricant, and a measurement device 3 for early detection of damage to roller bearing 2. Measurement device 3 is made up of a measurement sensor 4 and a measurement instrument 5, which has a circuit board, not shown, with integrated circuits, interfaces 6, 7 for the measurement sensor, and for a connection to an electric control of lubricant dispenser 1, as well as a battery, not shown. The measurement sensor 4 has a device supplied with power by measurement instrument 5, for recording analog measurement signals. The integrated circuits release the power supply of measurement sensor 4 at predetermined intervals, only for a short period of time, for example for several seconds at intervals of up to one hour. After the current measurement values are detected, the integrated circuits interrupt the power supply again. This measure allows a clear reduction in the power consumption of measurement device 3. In order to avoid voltage drops, the battery is soldered onto the circuit board. This arrangement results in an additional energy saving. Measurement device 3 can be operated for up to several years without changing the battery, as a result of the measures according to the invention. Because the battery is soldered on, the risk of spark formation at the contact points between the battery and the circuit board is prevented, so that measurement device 3 can also be used in areas protected against explosion. The battery is made up of a lithium battery having a battery housing welded to be pressure-sealed. Lithium batteries are so-called long-lasting batteries and allow a very long period of operation of measurement device 3 before a battery change becomes necessary. The battery housing welded to be pressure-sealed prevents the penetration of humidity, which can impair the function of the battery.

Measurement sensor 4 contains a semiconductor module for temperature measurements and a double-axis sensor for recording acceleration values. In this way, the start of bearing damage, which is always expressed by means of an increased bearing friction, i.e. by an increased vibration of roller bearing 2, can be detected early. The measurement sensor is equipped with an analog/digital converter, not shown. The extremely power-saving transport of the digital measurement signals from measurement sensor 4 to measurement instrument 5 results in a further lengthening of the battery lifetime. Measurement sensor 4 has an IC module for forming the average of the measurement signals. In this way, the importance of incorrect measurements as well as of short-term extreme values for-the lubricant supply is reduced.

Accordingly, although only at least one embodiment of the present invention have been shown and described, it is to be understood that many changes and modifications may be made thereunto without departing from the spirit and scope of the invention as defined in the appended claims.

What is claimed is:

1. A measurement device for early detection of damage to a machine part that is supplied with lubricant from a decentralized electromechanical lubricant dispenser having an electronic control comprising:
(a) a measurement sensor; and
(b) a measurement instrument comprising a circuit board having integrated circuits;
(c) a plurality of interfaces for said measurement sensor and for a connection to an electronic control of the lubricant sensor; and
(d) a battery soldered onto said circuit board to prevent voltage drops;
wherein said measurement sensor comprises a device for recording analog measurement signals supplied with power by said measurement instrument; and
wherein said integrated circuits release the power supplied to said measurement sensor at predetermined intervals for a short period of time relative to each of said intervals and interrupt the power supplied to said measurement-sensor after current measurement values have been detected.

2. The measurement device according to claim 1, wherein said battery comprises a lithium battery having a battery housing welded to be pressure-sealed.

3. The measurement device according to claim 1, wherein said measurement sensor contains a semiconductor module for temperature measurements or a double-axis sensor for recording acceleration values.

4. The measurement device according to claim 1, wherein said measurement sensor is equipped with an analog/digital converter.

5. The measurement device according to claim 1, wherein said measurement sensor has an IC module for forming an average of the measurement signals.
